(19) United States
(12) Patent Application Publication
(10) Pub. No.: US 2025/0363578 A1
(43) Pub. Date: Nov. 27, 2025

(54) SYSTEM AND METHOD TO TRACK MASTERY AND REWARD GAMIFICATION POINTS TO A USER ON AN ONLINE LEARNING PLATFORM

(71) Applicant: 2hr Learning, Inc., Austin, TX (US)

(72) Inventors: Philip Hewinson, Woking (GB); Samy Aboel-Nil, Austin, TX (US)

(73) Assignee: 2hr Learning, Inc., Austin, TX (US)

(21) Appl. No.: 19/218,318

(22) Filed: May 25, 2025

Related U.S. Application Data
(60) Provisional application No. 63/652,136, filed on May 27, 2024.

(51) Int. Cl. G06Q 50/20; G06Q 10/10

(52) U.S. Cl. CPC G06Q 50/205; G06Q 10/103

(57) ABSTRACT

A method is disclosed to track and differentiate a user's progress on an online learning platform through both academic mastery and gamification. The method involves accessing user-specific details to update a user profile and retrieve the user's selected topic of interest. A motivational and academic tracking system, comprising a mastery progress indicator and a points-based gamification system, is implemented. The online platform displays topic-relevant questions, receives user responses, and compares them against pre-stored answers to determine correctness. A tracking system analyzes user performance, distinguishing between academic mastery and gamified participation. Points are awarded for correct responses without penalizing incorrect ones, while mastery progress increases with correct answers and decreases with incorrect ones. The tracking system monitors performance and triggers a reward mechanism when mastery thresholds are achieved, thereby offering a personalized approach to learning engagement.

### CROSS-REFERENCE TO RELATED APPLICATION

This application claims the benefit under 35 U.S.C. § 119(e) and 37 C.F.R. § 1.78 of U.S. Provisional Application No. 63/652,136, filed May 27, 2024, which is incorporated by reference in its entirety.

### FIELD OF THE INVENTION

The present invention relates in general to the field of electronics, and more specifically to a system for tracking mastery on an online learning platform while simultaneously providing a motivational framework by rewarding gamification points to a user.

### BACKGROUND

Online educational platforms providing access to various educational topics are popular among students and other learning professionals. The popularity of the online educational platforms is attributed to several factors including—convenience of accessing content from any location using a computing device having stable internet connection, ability to study various courses at one's own pace, and the wide range of subjects and courses available on the platforms. Additionally, the online educational platforms cater to diverse learning styles and preferences, allowing students to choose courses that align with their interests and goals.

The conventional online educational platforms have long been characterized by a lack of sophisticated strategies to address student motivation and engagement. The online educational platforms, while advanced in delivering and assessing academic content, often fall short in fostering an environment where students are encouraged to take risks and are adequately motivated to engage deeply with the educational material. The conventional online educational platforms predominantly emphasize academic rigor and correctness, designed to measure progress based on the accuracy of responses. Typically, the conventional online educational platforms only reward correct answers, and incorrect ones are penalized, which can inadvertently cultivate a fear of failure among students. When students are apprehensive about making mistakes, they are less likely to engage in exploratory learning.

Moreover, in conventional online educational platforms, the operations are primarily focused on performance metrics. The online educational platforms usually operate on a principle to award points for correct answers and deduct points for incorrect answers. This method does not account for the complex nature of learning and the various factors that contribute to a student's academic journey. The fear of losing points or facing penalties for incorrect answers can create an environment where students become risk-averse. The student may choose to avoid challenging questions or novel problem-solving methods, preferring to stick to limited knowledge. The constant pressure to achieve correct answers and the associated penalties for mistakes can lead to heightened anxiety and stress among students. This stress can impair cognitive function, reducing the ability to think clearly and solve problems effectively. Over time, the accumulation of negative experiences associated with learning can lead to disengagement, where students lose interest and motivation to learn.

Additionally, the conventional online educational platforms often fail to account for the varying levels of difficulty in the questions they present. Typically, all questions are weighted equally when it comes to awarding points. This lack of differentiation can demotivate students who tackle more challenging content. For example, a student who successfully answers a particularly difficult question receives the same recognition as another student who answers a much simpler question correctly. This parity can be demotivating for students who seek to challenge themselves and master more complex material, as their efforts are not appropriately recognized or rewarded.

### SUMMARY

The present invention relates to tracking and rewarding user progress on an online learning platform using integrated gamification elements and proficiency monitoring through a dynamic tracking system.

In an embodiment, a method for tracking progress details of a user on an online learning platform is disclosed. The method includes executing code using one or more processors of a computer system to cause the computer system to perform operations. These operations begin by accessing one or more user details corresponding to the user for updating a user profile associated with the user on the online learning platform. The method further includes fetching a topic of interest selected by the user and implementing a tracking system within the platform. The tracking system comprises a mastery progress indicator configured to track the academic proficiency levels of the user, and a points system designed to incentivize participation and progress. A plurality of questions related to the selected topic of interest are displayed on a user interface of the platform. The system receives user responses to the questions and compares them to a plurality of pre-stored answers to identify correct or incorrect answers. Based on this assessment, gamification points are awarded only for correct answers without deducting points for incorrect ones. Additionally, both gamification points and mastery progress are increased for correct answers, while only the mastery progress is reduced for incorrect answers. A reward system is triggered when a mastery level of the user increases, thereby promoting continual engagement and improvement.

In another embodiment, a system for tracking progress details of a user on an online learning platform is disclosed. The system comprises one or more processors and a memory operatively coupled to the processors. The memory stores code which, when executed, causes the processors to perform operations comprising: accessing user-specific details to update the user's profile on the platform; fetching a user-selected topic of interest; and implementing a tracking system including a mastery progress indicator and a points system to monitor and reward academic progress. The system also includes a question delivery module that displays a plurality of topic-related questions on a user interface, and a response evaluation module to compare user responses with stored answers. A gamification mechanism awards points only for correct responses, avoids penalties for incorrect ones, and updates mastery indicators accordingly. A reward mechanism is activated upon detection of a mastery level increment to further incentivize user progress and engagement.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary mastery progress and gamification point tracking system to track the progress details of a user.

FIG. 2 depicts an exemplary process utilized by the mastery progress and gamification point tracking system of FIG. 1.

FIG. 3 is an exemplary flow diagram depicting the initialization of the mastery progress and gamification point tracking system of FIG. 1.

FIG. 4 is an exemplary flow diagram depicting the algorithm for the mastery progress and gamification point tracking system of FIG. 1.

FIGS. 5-13 depict exemplary user interface displays of the mastery progress and gamification point tracking system of FIG. 1.

FIG. 14 depicts an exemplary network environment in which the system of FIG. 1 and the process of FIG. 2 may be practiced.

FIG. 15 depicts an exemplary computer system.

### DETAILED DESCRIPTION

The mastery progress and gamification point tracking system allows dual tracking of the user and award users with both mastery progress and gamification points for learning activities, separately tracking academic progression and gamification incentives. The mastery progress is academically rigorous, so responds to both correct and incorrect answers. However, the points system is purely for motivation, and incorrect answers do not result in a loss of points. More points are awarded for correct answers on the first attempt and for correct answers to difficult questions, which optimizes for user motivation. This ensures that the mastery progress and gamification point tracking system provides a strong motivational model alongside being academically rigorous.

Furthermore, gamification points are only awarded for correct answers, not for incorrect answers, whereas incorrect answers do affect the mastery level of the user. This non-deductible gamification point ensures that the user stays motivated. The approach of not deducting points for incorrect answers and only adding points for correct answers addresses the psychological aspect of learning by reducing the fear of making mistakes. This non-deductible gamification point reduces the fear of making mistakes and encourages a trial-and-error learning method without penalizing the user. The motivational and academic tracking system encourages learning through trial and error without penalizing the user. While awarding gamification points, the system also identifies the difficulty level and considers the number of attempts the user made before arriving at the correct answer.

The motivational and academic tracking system is also configured to estimate the time required to complete a topic based on user interaction data, such as the average points per credit-based question and the time spent on a topic. This estimation of time provides actionable insights for the user in effective time management and personalized study planning. Also, the reward system is integrated into the online learning platform, enhancing the user experience by providing immediate positive reinforcement for incremental achievements in learning. The reward system is particularly effective in maintaining user engagement and motivation throughout the learning process.

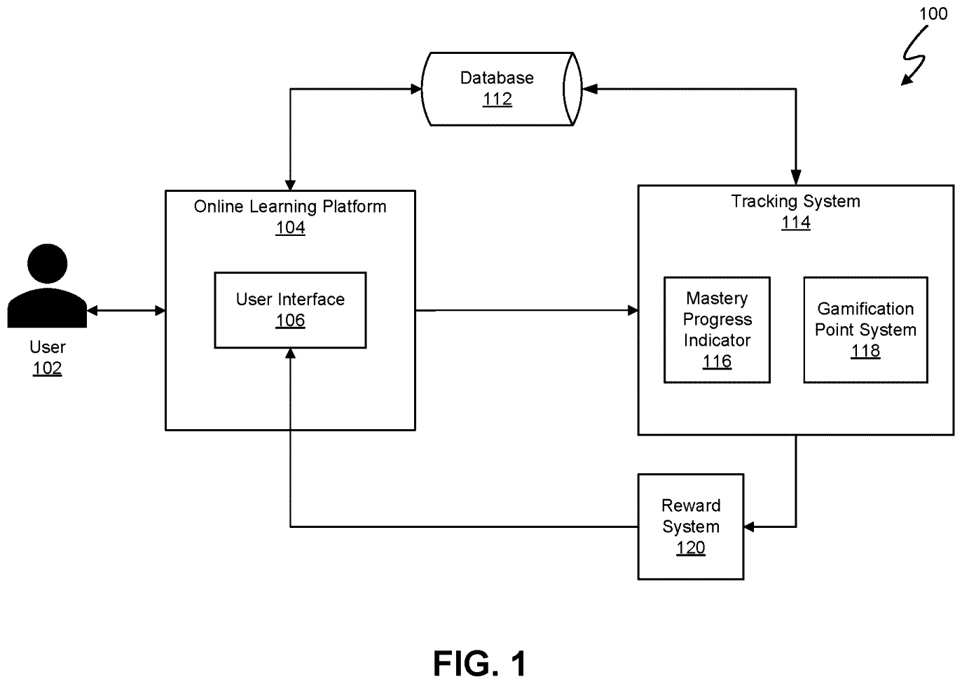

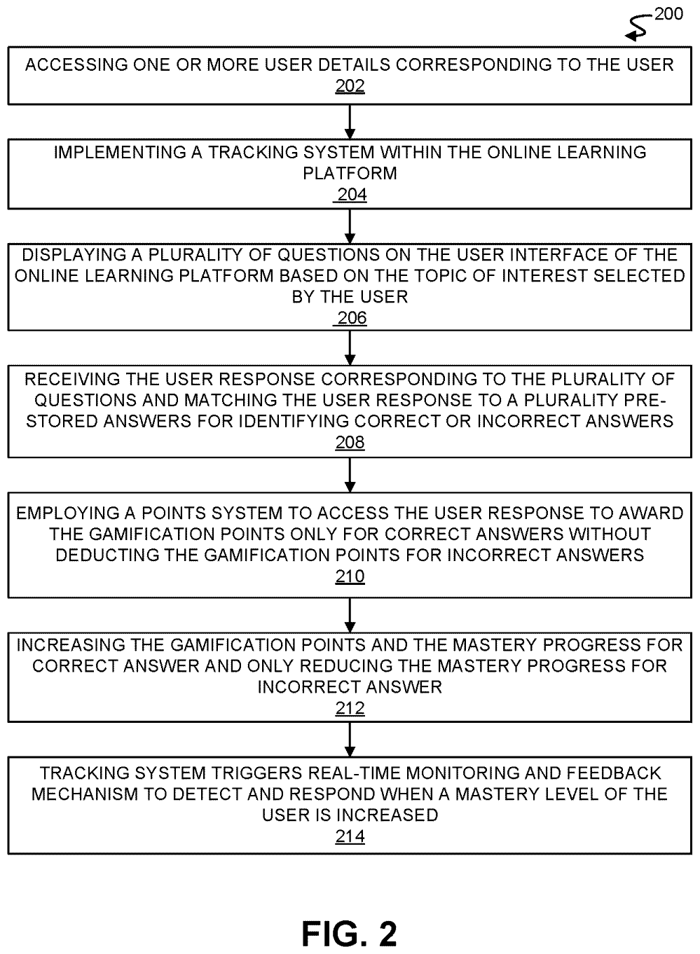

FIG. 1 depicts an exemplary motivational and academic tracking system 100 to track the progress details of a user 102. FIG. 2 depicts a process 200 utilized by the motivational and academic tracking system 100 to track the progress details of the user 102.

The motivational and academic tracking system 100 refers to a digital space where the user 102 interacts and engages with an online learning platform 104 through the internet. The motivational and academic tracking system 100 encompasses the online learning platform 104 that facilitates real-time communication, and collaboration among the user 102. In at least one embodiment, the online learning platform 104 includes features such as voice and text chat, leaderboards, virtual economies, and social networking elements displayed on a user interface 106 of the online learning platform 104. The online learning platform 104 aims to create immersive, interactive experiences by enhancing the educational experience by incorporating elements of fun for the user 102. The motivational and academic tracking system 100 includes a tracking system 114 configured to analyze data related to the user 102.

In operation 202, access one or more user details corresponding to the user. The online learning platform 104 is configured to access one or more user details for updating a user profile associated with the user 102 based on the one or more user details. The one or more user details are also utilized to fetch a topic of interest of the user 102. The topic of interest is selected by the user 102 from the plurality of topics of interest displayed on the user interface of the online learning platform 104. Typically, accessing user details starts with the user 102 authentication. The user 102 logs into the online learning platform 104 using the credentials, such as a username and password. Once authenticated, the online learning platform 104 identifies the user 102 through a unique identifier, which is linked to the user's profile stored in a database 112. The user profile contains information associated with the user 102, including name, age, educational background, preferences, and past interactions with the online learning platform 104. The online learning platform 104 continuously updates the user profile by capturing various user activities, such as courses taken, progress within those courses, assessment results, and time spent on different sections of the online learning platform 104. The online learning platform 104 is configured to dynamically update the user profile to ensure that the profile accurately reflects the current learning needs and interests of the user 102.

In at least one embodiment, for updating the user profile, the online learning platform 104 employs real-time learning analytics and user inputs. The real-time learning analytics involves monitoring and recording user interactions in real-time within the online learning platform 104. For example, when user 102 completes a chapter from the topic of interest, the online learning platform 104 records the completion along with the time taken. The one or more user details are used to update the progress status of the user 102, which also enables the online learning platform 104 to recommend further topics. The online learning platform 104 offers the user 102 the ability to select topics of interest. The topics include history, mathematics, science, geometry, and so forth. The user's selections of topics of interest are stored in the user profile for personalized content delivery. The online learning platform 104 analyzes user behavior and infers interests to generate personalized content. For example, if a user frequently views content related to mathematics, the online learning platform 104 infers a strong interest of the user 102 in mathematics and adjusts recommendations accordingly.

The personalized content delivery adheres to stringent data protection regulations, ensuring that the one or more user details are handled with confidentiality and security. The user interface 106 facilitates easy navigation and intuitive interaction with the online learning platform 104. The user interface 106 provides clear menus for managing of user profile, selecting topics of interest, and ensuring that the user 102 can engage with the online learning platform 104 with ease, thus enhancing the overall learning experience.

In operation 204, implement the tracking system 114 within the online learning platform 104. The tracking system 114 is designed to analyze the user 102 response on the online learning platform 104 by providing a comprehensive approach to track the academic proficiency while also keeping the user 102 motivated and engaged in the educational journey. The tracking system 114 comprises a mastery progress indicator 116 and a gamification point system 118. The tracking system 114 enhances both learning outcomes and user engagement by integrating the mastery progress indicator 116 and the gamification point system 118.

The mastery progress indicator 116 provides a detailed and accurate reflection of the understanding and mastery of the user 102 on a particular topic. The mastery progress indicator 116 responds to both correct and incorrect answers, ensuring that the assessment of knowledge is thorough and reflective of the user 102 capabilities. The mastery progress indicator 116 offers the user 102 clear insights into their strengths and areas that require improvement. The gamification point system 118 operates to incentivize the user 102 to actively participate and progress through their learning activities. The gamification points are awarded to user 102 when the user 102 gives a correct answer on the first attempt, or provides a correct answer on subsequent attempts, based on the difficulty level of the questions. The gamification points encourage user 102 to strive for accuracy and take on more difficult tasks, knowing that their efforts will be recognized and rewarded. The gamification point system 118 does not penalize user 102 for incorrect answers. This allows the user 102 to learn without the fear of losing points, which can be demotivating. The gamification point system 118 awards more points for correct answers, particularly those achieved on the first try and those associated with more complex questions. The tracking system 114 ensures that the user 102 is both academically challenged and motivated to engage deeply with the content. The mastery progress indicator 116 focuses on academic rigor and proficiency, the gamification point system 118, on the other hand, ensures that the process remains enjoyable and engaging. This balance maintains long-term motivation and prevents burnout

The mastery progress indicator 116 is designed to monitor and display the academic proficiency levels of the user 102 in real-time. The mastery progress indicator 116 employs a range of metrics to assess how well the user 102 has understood and mastered concepts and skills. The mastery progress indicator 116 analyzes performance data of the user, the performance data includes scores from quizzes, assignments, and tests. The mastery progress indicator 116 translates the performance data into a proficiency level for each topic of interest. The gamification point system 118 is designed to incentivize participation and progress by integrating game-like elements into the online learning platform 104. The gamification point system 118 involves applying game features such as points, badges, leaderboards, and rewards to the online learning platform 104. The gamification point system 118 operates by awarding points to the user 102 for completing various learning activities and milestones on the online learning platform 104. The learning activities can range from completing the topic of interest, completing a chapter from the topic of interest, or completing a quiz and assignments. The user 102 accumulates gamification points to unlock rewards such as badges, certificates. The gamification point system 118 motivates the user 102 to engage more actively with the online learning platform 104 and also fosters a sense of accomplishment and progress. The gamification point system 118 adds an element of fun and excitement to the learning process. By rewarding the user 102 for their efforts and achievements, it encourages the user 102 to engage more deeply with the educational content.

The gamification point system 118 includes multiple layers of rewards to cater to different types of questions, such as multiple choice questions, fill-in-the-blank questions, or truth or lie displayed on the user interface 106 of the online learning platform 104. For example, let's consider a user, Alex, who is using the online learning platform 104 to prepare for an upcoming exam. Alex selects a topic to study and begins answering questions. The online learning platform 104 presents a mix of multiple-choice and fill-in-the-blank questions of varying difficulty. Alex answers a multiple-choice question correctly on the first attempt. The gamification point system 118 awards Alex 2 points for the correct answer and updates the mastery progress indicator 116. Next, Alex attempts a fill-in-the-blank question, which is more challenging. Alex answers correctly on the first attempt, so the gamification point system 118 awarded 3 points due to the more challenging nature of the question, and Alex's mastery progress indicator 116 increases as well. Next, Alex attempts another multiple-choice question. After two incorrect attempts, Alex provides the correct answer. The gamification point system 118 awards only 1 point due to the multiple attempts, but the mastery progress indicator 116 decreases as the incorrect attempts imply lower mastery of the topic than they previously had. As Alex continues to answer questions correctly, the gamification point system 118 provides positive feedback and updates the points, keeping Alex motivated. When Alex achieves a new mastery level on the topic, the online learning platform 104 celebrates the milestone with a “Topic completion” displayed on the user interface 106 of the online learning platform 104, further motivating Alex to continue learning.

The online learning platform 104 accesses a curriculum database to align the plurality of questions with the educational standards. The online learning platform 104 refers to the curriculum database, which contains detailed information about the topics and content covered in the educational standards for that topic. The curriculum database is aligned to one or more educational standards, including Common Core State Standards (CCSS), Next Generation Science Standards (NGSS), College Board, and so on, which houses comprehensive details of each topic included in the curriculum.

In operation 206, display a plurality of questions on the user interface 106 of the online learning platform 104 based on the topic of interest selected by the user 102. When the user 102 logs into the online learning platform 104, the user 102 selects the topic of interest. The topics are categorized to ensure a broad range of interests, and the educational standards are covered. The user 102 navigates the user interface 106 and selects the topic of interest that aligns with the learning objectives. The selection is recorded by the online learning platform 104. Once the topic of interest is selected, the plurality of chapters associated with the topic is displayed on the user interface 106 of the online learning platform 104. Notably, the online learning platform 104 retrieves a plurality of questions related to the chapter selected by the user 102 corresponding to the topic of interest from the database 112. The database 112 comprises the plurality of questions to cover difficulty levels. The plurality of questions includes information about the topic, difficulty level, and educational objectives.

The plurality of questions is displayed based on the user's past performance, learning preferences. For example, if the user 102 has previously demonstrated proficiency in basic algebra, the online learning platform 104 prioritizes advanced algebra questions to challenge the user 102 and promote further learning. Conversely, if the user 102 has struggled with certain concepts, the online learning platform 104 selects questions that reinforce foundational knowledge before progressing to more complex topics. Once the relevant questions have been retrieved, the questions are displayed on the user interface 106. The user interface 106 ensures that the user 102 can navigate and engage with the questions. Typically, the questions are presented in a format that allows for intuitive interaction, such as multiple-choice questions, fill-in-the-blank, or truth or lie. The user interface 106 also includes features such as hints and explanations to support the learning process of the user 102.

The online learning platform 104 ensures that the questions are presented in a way that maintains the engagement and interest of the user 102. This involves randomizing the order of questions, varying the question types, and periodically introducing new questions to keep the content fresh and challenging. Furthermore, the online learning platform 104 may employ adaptive learning techniques to dynamically adjust the difficulty level and type of questions based on the user's performance in real-time. For example, if the user 102 answers several questions correctly in a row, the online learning platform 104 increases the difficulty level of subsequent questions to provide a greater challenge. Conversely, if the user 102 struggles with a series of questions, the online learning platform 104 presents easier questions or provides additional resources to help the user 102 improve understanding.

In operation 208, receive the user response corresponding to the plurality of questions and match the user response to a plurality of pre-stored answers to identify if the provided answer is correct or incorrect. When the user 102 interacts with the online learning platform 104, a plurality of questions related to the topic of interest are displayed via the user interface 106. As the user 102 proceeds to answer the questions, the response is captured by the online learning platform 104 in real-time. In this regard, the user interface 106 is responsive and intuitive, allowing the user 102 to input the answers easily. Once the user 102 submits a response on the online learning platform 104, the online learning platform 104 ensures that the response data is accurately recorded. For example, if the user 102 is answering a multiple-choice question, the online learning platform 104 records the option chosen by the user 102.

The online learning platform 104 is configured to match the user's response against the database 112 that includes the pre-stored answers. Each question in the database 112 is associated with one or more correct answers. Matching the user response to the pre-stored answers involves a comparison to check if the user's response matches the correct answers. Once the comparison is complete, the online learning platform 104 identifies whether the user's response is correct or incorrect. For example, for objective questions, if the user's response matches a correct answer, it is marked correct; otherwise, it is marked incorrect.

In operation 210, employ a gamification point system 118 to access the user's response to award the gamification points only for correct answers, without deducting the gamification points for incorrect answers. The gamification point system 118 operates on a positive reinforcement, to award the gamification points only for correct answers without deducting the gamification points for incorrect answers to encourage the user 102 to continue engaging with the learning. When the user 102 interacts with the online learning platform 104, the answers to questions are recorded in real-time. The online learning platform 104 distinguishes between correct and incorrect answers based on pre-stored answers for identifying correct or incorrect answers. Once the online learning platform 104 identifies a correct answer, the gamification points are awarded. The gamification points serve as a form of positive feedback, providing immediate recognition of the user 102 success. The gamification points awarded can vary based on several factors, such as the difficulty level of the question, the speed of the response, and whether the answer was correct on the first attempt to ensure that the gamification point system 118 remains engaging and rewarding, motivating the user 102 to strive for higher levels of achievement.

The non-deductible nature of the gamification point system 118 allows the incorrect answers not to result in a loss of points. The gamification point system 118 is designed to maintain a positive learning environment. When the user 102 knows that an incorrect answer will not lead to a reduction in gamification points, the user 102 is more likely to explore and learn from their errors. The gamification point system 118 continuously awards points for correct answers and avoids penalties for incorrect answers, the online learning platform 104 can provide valuable insights into the user 102 progress.

In operation 212, increase the gamification points and the mastery progress for correct answer and only reducing the mastery progress for incorrect answer. Increasing gamification points and mastery progress for correct answers, thereby encouraging the user 102 to actively engage with the material and strive for accuracy. While reducing mastery progress for incorrect answers is aimed for optimizing user motivation, engagement, and learning outcomes within the online educational platform 104. Additionally, by only reducing mastery progress for incorrect answers, the online educational platform 104 mitigates the negative impact of mistakes on the user 102 morale and motivation. By maintaining the gamification points for incorrect answers, the online educational platform 104 incentivizes the user 102 to persevere through challenges, take risks, and learn from their mistakes.

When the user 102 interacts with the online educational platform 104, the answers to the questions are analyzed in real-time to determine their correctness. For correct answers, both gamification points and mastery progress are incremented, reflecting the user's understanding and proficiency in the subject matter. For incorrect answers the gamification points may remain unchanged while the mastery progress is reduced. This reduction serves as a form of corrective feedback, signaling to the user 102 to improve on the corresponding topic. By adjusting mastery progress based on user responses, the online educational platform 104 provides valuable insights into the user 102 strengths and weaknesses. The gamification points and the mastery progress sustains motivation and engagement of the user 102 throughout the learning process. The user 102 feels rewarded for their active involvement, fostering a sense of accomplishment and progress.

In operation 214, tracking system 114 triggers a reward system 120 in real-time to detect and respond when a mastery level of the user 102 is increased. Typically, a plurality of algorithms track and differentiate between the mastery progress and the gamification points. The plurality of algorithms assess the correctness of answers and adjust the mastery level of the user accordingly. Furthermore, a conditional logic is utilized to ensure that the points are incremented only upon correct answers. Additionally, the conditional logic adjusts the increment of the gamification points based on the difficulty level of the plurality of questions and the performance of the user. Conditional logic is utilized to ensure that points are incremented only upon correct answers. When the user 102 provides an answer, the online learning platform 104 evaluates its correctness. If the answer is correct, the online learning platform 104 triggers an action to increment the gamification points. This ensures that gamification points are awarded accurately, reinforcing the importance of providing correct answers and maintaining the integrity of the reward system 120. By using conditional logic, the online learning platform 104 effectively motivates the user 102 to strive for accuracy and reinforces positive learning behaviors.

The reward system 120 identifies patterns and trends in the user 102 behavior that indicate progress towards mastery level. The patterns include improvements in accuracy, speed, or question-solving, as well as increased engagement. By detecting these patterns, the Al engine 108 can infer when the user 102 mastery level is increasing. The reward system 120 monitors the user 102 behavior, the Al engine 108 provides real-time feedback to the user 102 to support their learning journey. The feedback may take various forms, including interactive exercises, hints and explanations, personalized recommendations for additional resources or practice activities, and encouragement and praise for achievements to motivate the user 102 to continue progressing towards mastery. As the user 102 demonstrates increased mastery over time, the Al engine 108 adjusts its feedback to provide more challenging tasks. The adaptive approach ensures that the user 102 is continually challenged and engaged, preventing stagnation and promoting continuous improvement. In at least one embodiment, the reward system 120 is capable of processing and analyzing large volumes of user data with minimal latency

The reward system 120 helps the user 102 to identify areas for improvement and take proactive steps to address them. Moreover, real-time monitoring and feedback mechanisms facilitate a deeper understanding of complex concepts and skills by providing immediate reinforcement and clarification. The user 102 receives instant feedback on their performance, enabling them to correct errors, clarify misunderstandings, and consolidate their learning in real-time. Additionally, the reward system 120 enhances user motivation and engagement by providing tangible rewards and recognition for progress. The user 102 receives immediate feedback on their achievements, such as completing a challenging task, mastering a difficult concept, or reaching a milestone in their learning journey.

The pseudo code for implementing the tracking system within the online learning platform 104 is mentioned below:

```
# Initialize user's mastery and points
user_mastery = {“Topic1”: {“mastery_level”: 0, “points”: 0}, ...}
user_current_topic = null
# Function to update mastery and points after user answers a question
def update_mastery_and_points(topic, is_correct, attempt_count,
difficulty_level):
  # Update mastery based on correctness and attempt count
  if is_correct:
    user_mastery[topic][“mastery_level”] +=
calculate_mastery_increment(attempt_count)
  # Update points based on difficulty and attempt count
user_mastery[topic][“points”] +=
calculate_points(difficulty_level, attempt_count)
  else:
    user_mastery[topic][“mastery_level”] −=
calculate_mastery_decrement( )
# Function to calculate mastery increment
def calculate_mastery_increment(attempt_count):
  # Mastery increment logic based on the number of attempts
  if attempt_count == 1:
  return mastery_increment_first_try
  else:
  return mastery_increment_subsequent_tries
# Function to calculate mastery decrement
def calculate_mastery_decrement( ):
  # Mastery decrement logic
  return mastery_decrement_value
# Function to calculate points
def calculate_points(difficulty_level, attempt_count):
  # Points calculation logic based on difficulty level and attempt
count
  base_points = difficulty_points_mapping[difficulty_level]
  if attempt_count == 1:
  return base_points
  else:
  return max(base_points − (attempt_count − 1), minimum_points)
# Function to estimate time to study/complete a Topic
def estimate_study_time(topic):
  # Estimate time based on user interaction data
  average_points = calculate_average_points(topic)
  average_time_per_item = calculate_average_time_per_item(topic)
  return average_points * average_time_per_item
# Function to calculate average points per Topic
def calculate_average_points(topic):
  # Logic to calculate average points
  total_points = sum([user_mastery[topic][“points”] for topic in
user_mastery])
  total_topics = len(user_mastery)
  return total_points / total_topics
# Function to calculate average time spent per content item
def calculate_average_time_per_item(topic):
  # Logic to calculate average time
  total_time = sum([time_spent_ on_item for time_spent_on_item in
user_interaction_data[topic]])
  total_items = len(user_interaction_data[topic])
  return total_time / total_items
```

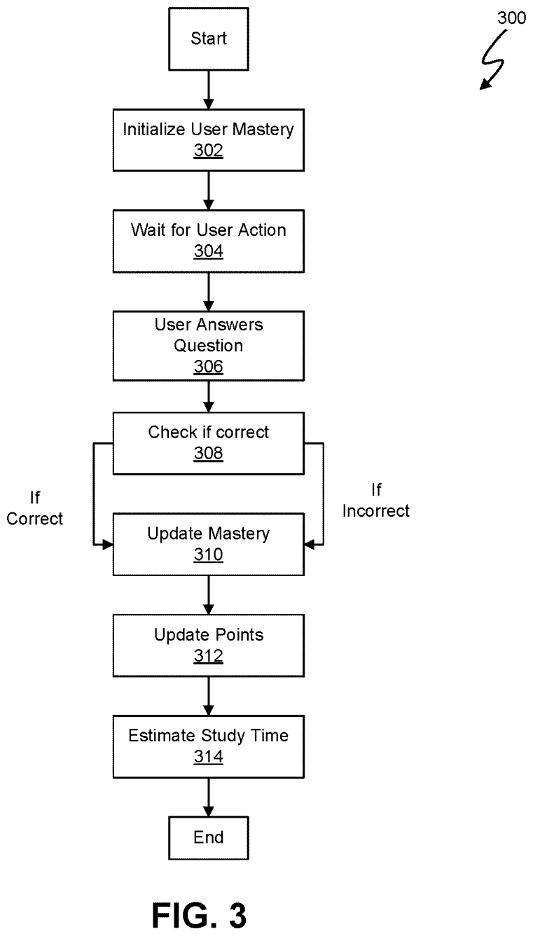

Referring to FIG. 3 is a flow diagram 300 depicting the initialization of the mastery progress. As shown at step 302, initialize user mastery to provide a reference point for assessing the user's current proficiency level in a topic of interest. Initializing user mastery involves evaluating existing knowledge, skills, and competencies of the user 102 in the topic of interest to determine the initial mastery level of the user 102. At step 304, wait for user action, once the user's mastery level has been initialized, the online educational platform 104 begins to track the user progress and growth over time. This tracking involves monitoring various metrics, such as performance on quizzes or assessments, completion of learning modules or activities, and engagement with learning materials. At step 306, user answer questions, once the mastery progress is initialized, the online educational platform 104 is configured to display the question based on the topic of interest of the user 102. The user 102 answers the questions are displayed on the user interface 106 of the online educational platform 104. At step 308, check if the user answer is correct, the online educational platform 104 is configured to analyze the user response to check whether the user response is correct or not. Based on the user response the user mastery progress and the gamification points is updated. In particular, in case of the right answer the mastery progress and the gamification points is increased. However, in case of the wrong answer reducing the mastery progress without deducting the gamification points.

At step 310, update mastery, after analyzing the user response and identifying the user response is correct corresponding to the displayed question. The mastery progress of the user 102 is updated. In the case of the correct answer, the mastery progress is increased, however, in the case of the wrong answer, the mastery progress is reduced. At step 312, update points, the gamification points are increased when the user's response is correct, and in case of a wrong answer, the gamification points are not deducted. At step 314, estimate study time, calculating the amount of time the user 102 spent to complete a specific learning task or module.

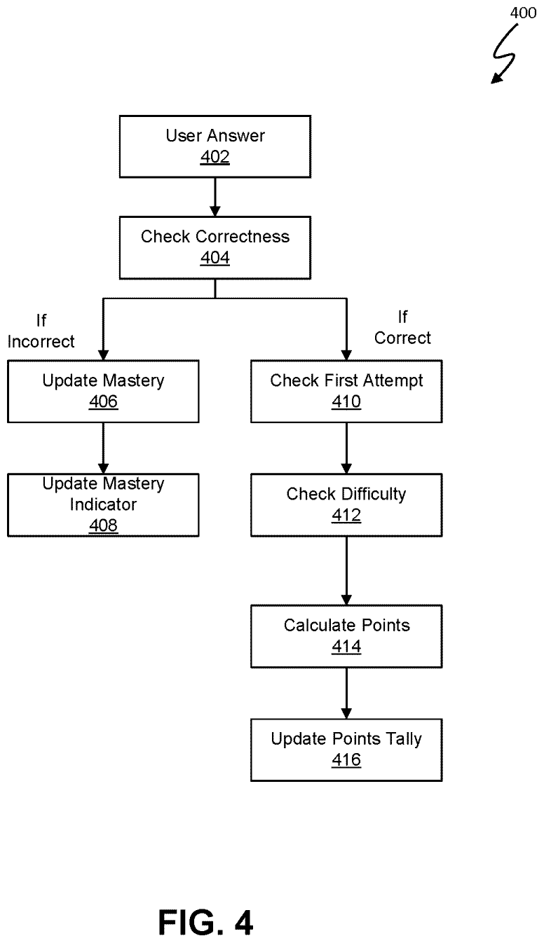

Referring to FIG. 4 is a flow diagram 400 depicting the initialization of the mastery progress and gamification point. As shown, at step 402, the user 102 provides the response in the form of answer to the question displayed on the user interface 106 of the online learning platform 104. At step 404, based on the user response, the online learning platform 104 is configured to check the correctness of the user response. If the user response corresponding to the displayed question is incorrect, at 406 the online learning platform 104 is configured to update the master progress. At step 408, online learning platform 104 updates the mastery progress by reducing the mastery score. However, if the answer is correct, at step 410, the online learning platform 104 is configured to identify whether the user has provided the answer in the first attempt. At step 412, the online learning platform 104 is configured to identify the difficulty level of the question displayed on the user interface 10 of the online learning platform 104. At step 414, based on the number of attempts user 102 takes to answer the question and the difficulty level of the question the online learning platform 104 calculates the gamification points. Typically, if the user 102 answers the question at first attempt then higher gamification points are given to the user 102 as compared to the second attempt and so on. At step 416, based on the calculation the gamification points of the user 102 is updated in the user interface 106 of the online learning platform 104.

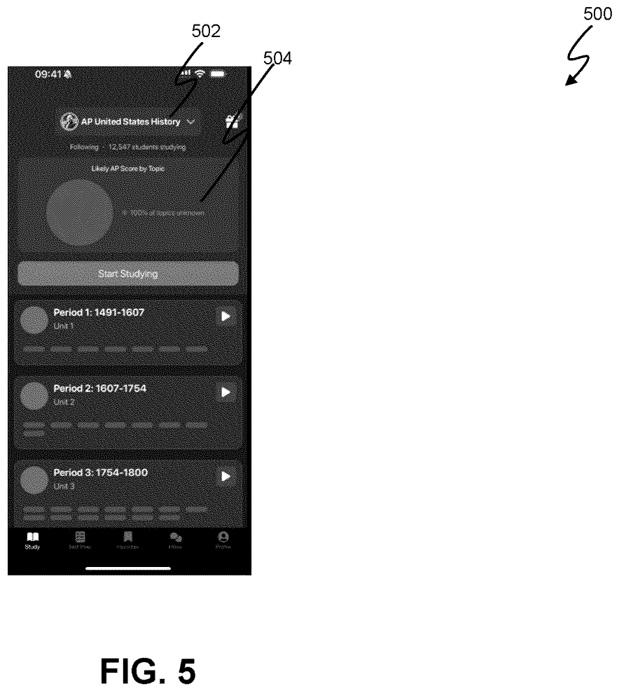

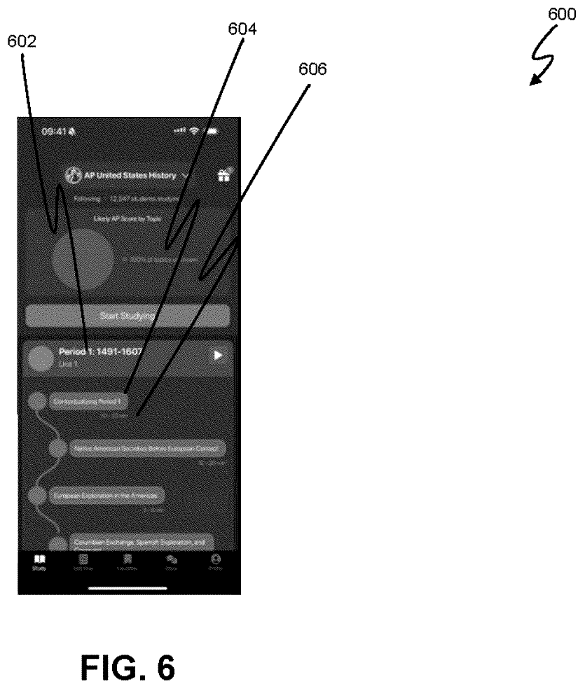

FIGS. 5-13 depict exemplary user interface displays 500, 600, 700, 800, 900, 1000, 1100, 1200, 1300 of the online learning platform 104. Referring to FIG. 5, as shown, the user 102 selects a topic of interest 502 displayed on the user interface 500 of the online learning platform 104. Moreover, the user interface 500 also depicts a topic status 504 that the corresponding topic of interest 502 is 100% unknown to the user 102. Referring to FIG. 6, as shown, the user 102 selects a subtopic 602 from the topic of interest. The user interface 600 displays a plurality of chapters 604 of the corresponding subtopic 602. Moreover, the user interface also shows the completion time 606 related to the plurality of chapters 604 of the corresponding subtopic 602.

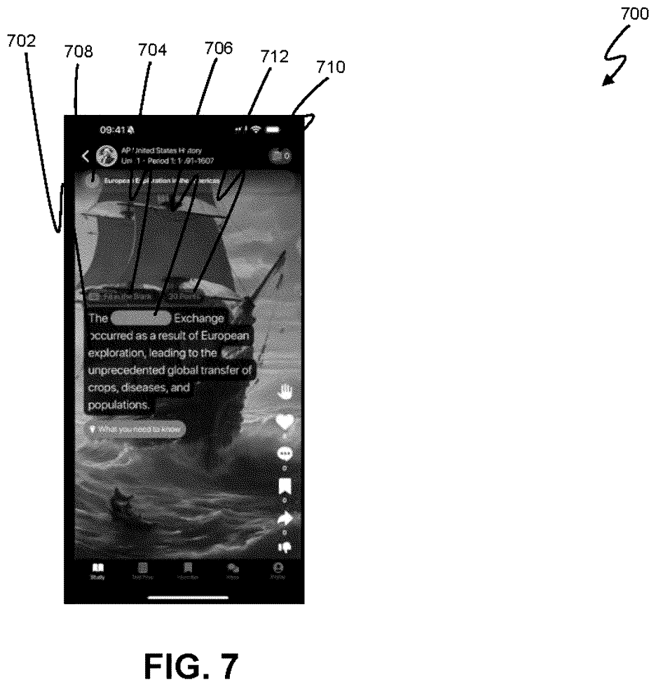

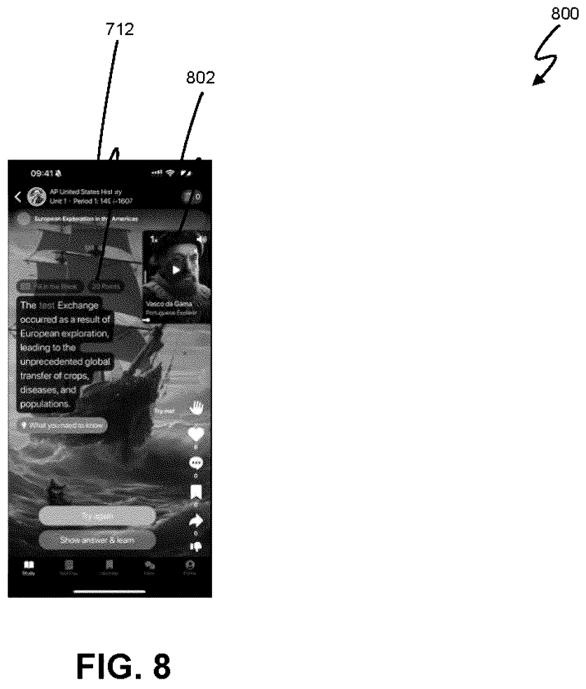

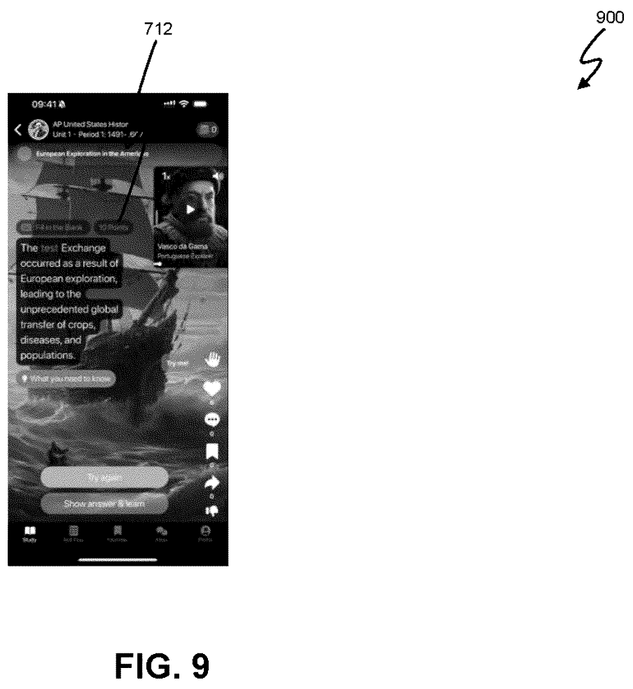

Referring to FIG. 7, as shown a question 702 is displayed on the user interface 700 of the online learning platform 104. The user interface 700 also shows a type of question 704, where the type of question 704 is a fill-in-the-blank type. Additionally, the user 102 is provided with a blank 706 for the answer to the question 702. Moreover, the user interface 700 depicts mastery progress 708 and gamification points 710. Furthermore, the user interface 700 displays points 712 associated with the correct answer to the displayed question to depict the maximum points the user can review while providing the answer. Referring to FIG. 8, as the user provides the wrong answer of the question 702 the points 712 is reduced from ‘30’ to ‘20’. Moreover, on the wrong answer, a popup 802 is displayed on the user interface 800 to explain the question to help the user 102 to provide the correct answer. Referring to FIG. 9, the user interface 900 depicts, when the user 102 again provides the wrong answer of the question 702 the points 712 is further reduced from ‘20’ to ‘10’

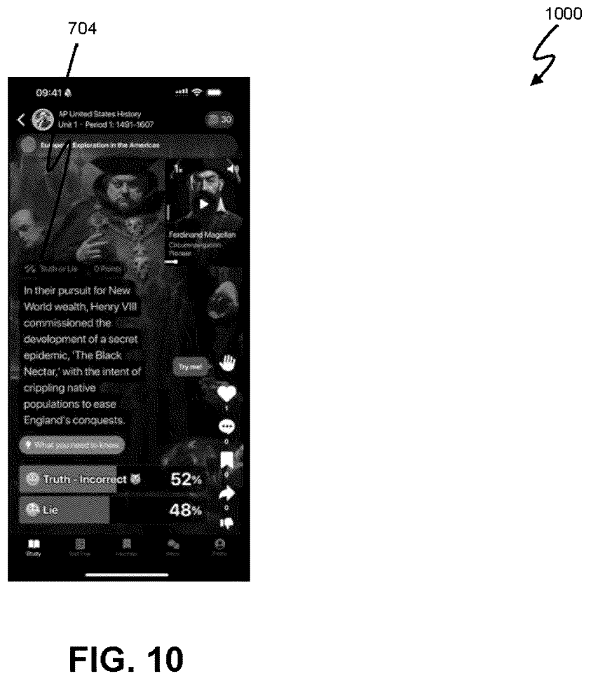

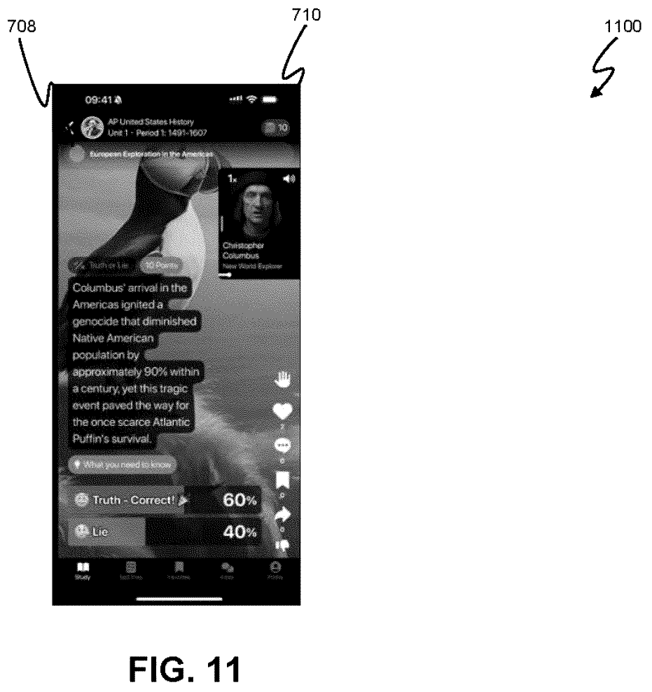

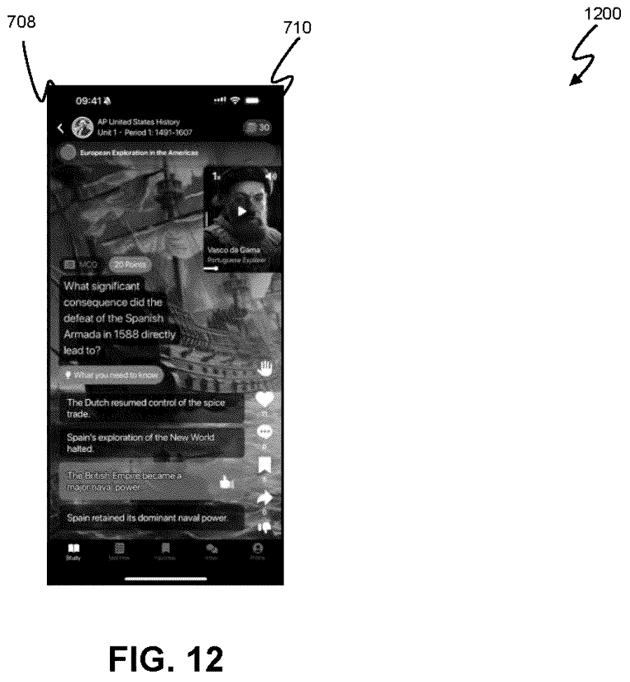

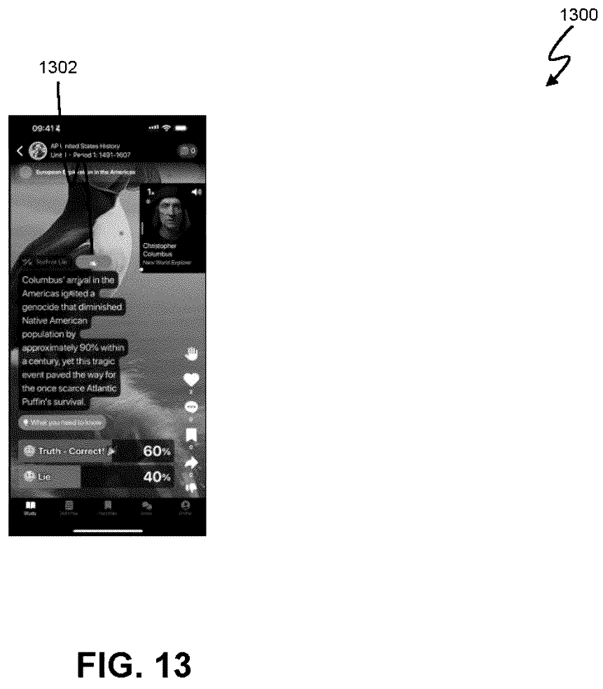

Referring to FIG. 10, as shown another question is displayed on the user interface 1000 of the online learning platform 104. Herein, the type of question 704 is a truth or lie type. As the user 102 provides an incorrect answer so no points are given to the user 102. Referring to FIG. 11, is another truth or lie type question. The user 102 provides a correct answer. So both the mastery progress 708 and the gamification points 710 of the user 102 are increased. Referring to FIG. 12, a multiple-choice question is displayed on the user interface 1200 of the online learning platform 104. The user 102 provides a correct answer, so both the mastery progress 708 and the gamification points 710 are increased. Referring to FIG. 13, displays a question that is not carrying any points 1302. The question is to boost the confidence of the user 102

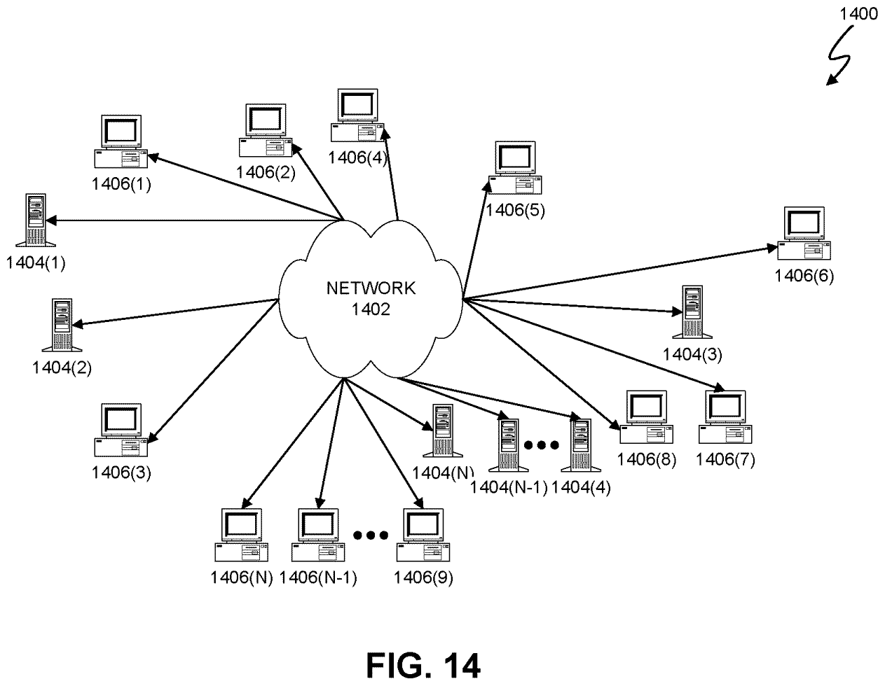

FIG. 14 is a block diagram illustrating a network environment 1400 in which the motivational and academic tracking system 100 and motivational and academic tracking process 200 may be practiced. Network 1402 (e.g. a private wide area network (WAN) or the Internet) includes a number of networked server computer systems 1404(1)-(N) that are accessible by client computer systems 1406(1)-(N), where N is the number of server computer systems connected to the network. Communication between client computer systems 1406(1)-(N) and server computer systems 1404(1)-(N) typically occurs over a network, such as a public switched telephone network over asynchronous digital subscriber line (ADSL) telephone lines or high-bandwidth trunks, for example communications channels providing T1 or OC3 service. Client computer systems 1406(1)-(N) typically access server computer systems 1404(1)-(N) through a service provider, such as an internet service provider (“ISP”) by executing application specific software, commonly referred to as a browser, on one of client computer systems 1406(1)-(N).

Client computer systems 1406(1)-(N) and/or server computer systems 1404(1)-(N) are specialized computers programmed to improve conventional computer systems to implement and utilize the motivational and academic tracking system 100 and motivational and academic tracking process 200. The type of computer system that can be specially programmed to implement and utilize the motivational and academic tracking system 100 and motivational and academic tracking process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the motivational and academic tracking system 100 and motivational and academic tracking process 200 can be implemented using code stored in a tangible, non-transient computer-readable medium and executed by one or more processors. In at least one embodiment, the motivational and academic tracking system 100 and motivational and academic tracking process 200 can be implemented completely in hardware using, for example, logic circuits and other circuits, including field programmable gate arrays.

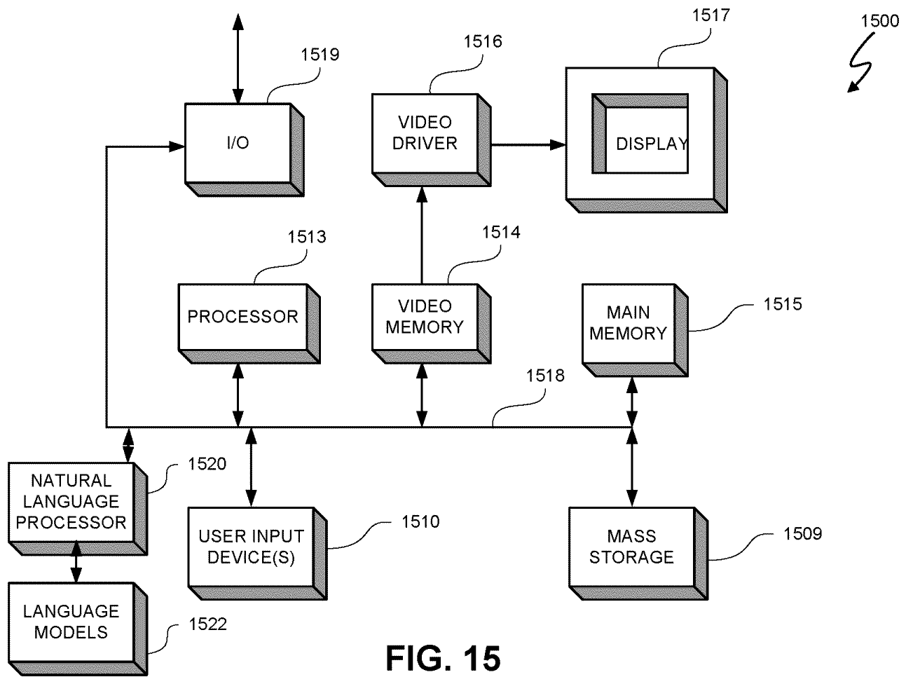

Embodiments of the motivational and academic tracking system 100 and motivational and academic tracking process 200 can be implemented on a computer system such as a special-purpose, special-programmed computer 1500 illustrated in FIG. 15. Input user device(s) 1510, such as a keyboard and/or mouse, are coupled to a bi-directional system bus 1518. The input user device(s) 1510 are for introducing user input to the computer system and communicating that user input to processor 1513. The computer system of FIG. 15 generally also includes a non-transitory video memory 1514, non-transitory main memory 1515, and non-transitory mass storage 1509, all coupled to bi-directional system bus 1518 along with input user device(s) 1510 and processor 1513. The mass storage 1509 may include both fixed and removable media, such as a hard drive, one or more CDs or DVDs, solid state memory including flash memory, and other available mass storage technology. Bus 1518 may contain, for example, 32 of 64 address lines for addressing video memory 1514 or main memory 2015. The system bus 1518 also includes, for example, an n-bit data bus for transferring DATA between and among the components, such as CPU 1509, main memory 1515, video memory 1514, and mass storage 2009, where “n” is, for example, 32 or 64. Alternatively, multiplex data/address lines may be used instead of separate data and address lines.

I/O device(s) 1519 may provide connections to peripheral devices, such as a printer, and may also provide a direct connection to a remote server computer system via a telephone link or to the Internet via an ISP. I/O device(s) 1519 may also include a network interface device to provide a direct connection to a remote server computer system via a direct network link to the Internet via a POP (point of presence). Such a connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1509, into main memory 1515 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1513, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1515 is comprised of dynamic random access memory (DRAM). Video memory 1514 is a dual-ported video random access memory. One port of the video memory 1514 is coupled to the video amplifier 1516. The video amplifier 1516 is used to drive the display 1517. Video amplifier 1516 is well known in the art and may be implemented by any suitable means. This circuitry converts pixel DATA stored in video memory 2014 to a raster signal suitable for use by display 1517. Display 1517 is a type of monitor suitable for displaying graphic images.

The computer system described above is for purposes of example only. The motivational and academic tracking system 100 and the motivational and academic tracking process 200 may be implemented in any type of computer system or programming or processing environment. It is contemplated that the motivational and academic tracking system 100 and motivational and academic tracking process 200 might be run on a stand-alone computer system, such as the one described above. The motivational and academic tracking system 100 and the motivational and academic tracking process 200 might also be run from a server computer systems system that can be accessed by a plurality of client computer systems interconnected over an intranet network.

Finally, the motivational and academic tracking system 100 and the motivational and academic tracking process 200 may be run from a server computer system that is accessible to clients over the Internet. Although embodiments have been described in detail, it should be understood that various changes, substitutions, and alterations can be made hereto without departing from the spirit and scope of the invention as defined by the appended claim.

What is claimed is:

1. A method for tracking progress details of a user on an online learning platform comprising:
executing code using one or more processors of a computer system to cause the computer system to perform operations comprising:
accessing one or more user details corresponding to the user for:
updating a user profile associated with the user based on the one or more user details related to the online learning platform;
fetching a topic of interest of the user, wherein the topic of interest is selected by the user;
implementing a tracking system within the online learning platform, including:
a mastery progress indicator to track academic proficiency levels of the user;
a points system to incentivize participation and progress on the online learning platform of the user;
displaying a plurality of questions on a user interface of the online learning platform based on the topic of interest selected by the user;
receiving the user response corresponding to the plurality of questions and matching the user response to a plurality of pre-stored answers for identifying correct or incorrect answer;
employing the points system to access the user response to award the gamification points only for correct answers without deducting the gamification points for incorrect answers;
increasing the gamification points and the mastery progress for correct answer and only reducing the mastery progress for incorrect answer; and
tracking system triggers a reward system to detect and respond when a mastery level of the user is increased.

2. The method of claim 1 further comprising:
enabling the reward system on the online learning platform, wherein the reward system is configured to:
acknowledge when the mastery level of the user is increased; and
enhance user engagement through positive reinforcement mechanisms.

3. The method of claim 1 further comprising:
utilizing a learning analytics on the online learning platform to:
provide the user with estimated time for completing the topic of interest selected by the user; and
analyze the one or more user details to inform the estimation of time.

4. The method of claim 1 further comprising:
using a plurality of algorithms to:
track and differentiate between the mastery progress and the gamification points; and
assess the correctness of answers and adjust the mastery level of the user accordingly.

5. The method of claim 1 further comprising:
incorporating a conditional logic to:
ensure that the points are incremented only upon correct answers; and
adjust the increment of the gamification points based on difficulty level of the plurality of questions and performance of the user.

6. The method of claim 1, wherein monitoring the user responses corresponding to the plurality of questions include identifying number of attempts taken by the user for providing the correct answer.

7. The method of claim 1, wherein monitoring the user responses corresponding to the plurality of questions for:
increasing the mastery level corresponding to the correct answers provided by the user; and
decreasing the mastery level corresponding to the incorrect answers provided by the user.

8. The method of claim 1 further comprising:
accessing a curriculum database to align the plurality of questions with the educational standards.

9. The method of claim 1 further comprising:
storing the one or more user details, plurality of questions, user response, mastery progress and gamification points into a database.

10. The method of claim 1, wherein awarding higher gamification points to the user for providing correct answers on first attempt and providing correct answers for higher difficulty level question from the plurality of questions.

11. The method of claim 1 wherein mastery level of the user keeps on updating in real-time based on the user response corresponding to the displayed question from the plurality of questions.

12. The method of claim 1 wherein the plurality of questions provided to the user include a mixed set of questions across all standards related to a topic.

13. A system for tracking progress details of a user on an online learning platform comprising:
one or more processors;
memory, operatively coupled to the one or more processors that when executed cause the one or more processors to perform operations comprising:
executing codes using one or more processors of a computer system to cause the computer system to perform operations comprising:
accessing one or more user details corresponding to the user for:
updating a user profile associated with the user based on the one or more user details on the online learning platform;
fetching a topic of interest of the user, wherein the topic of interest is selected by the user;
implementing a tracking system within the online learning platform, including:
a mastery progress indicator to track academic proficiency levels of the user;
a points system to incentivize participation and progress on the online learning platform of the user;
displaying a plurality of questions on a user interface of the online learning platform based on the topic of interest selected by the user;
receiving the user response corresponding to a question and matching the user response to a plurality pre-stored answers for identifying correct or incorrect answer;
employing the points system to access the user response to award the gamification points only for correct answers without deducting the gamification points for incorrect answers;
increasing the gamification points and the mastery progress for correct answer and only reducing the mastery progress for incorrect answer; and
tracking system triggers a reward system to detect and respond when a mastery level of the user is increased.

14. The system of claim 13 further comprising:
the reward system provided on the online learning platform, wherein the reward system is configured to:
acknowledge when the mastery level of the user is increased; and
enhance user engagement through positive reinforcement mechanisms.

15. The system of claim 13 further comprising:
a learning analytics provided on the online learning platform to:
provide the user with estimated time for completing the topic of interest selected by the user; and
analyze the one or more user details to inform the estimation of time.

16. The system of claim 13 further comprising:
a plurality of algorithms configured to:
track and differentiate between the mastery progress and the gamification points; and
assess the correctness of answers and adjust mastery level of the user accordingly.

17. The system of claim 13 further comprising:
a conditional logic configured to:
ensure that the points are incremented only upon correct answers; and
adjust the increment of the gamification points based on difficulty level of the plurality of questions and performance of the user.

18. The system of claim 13 further comprising:
a curriculum database referred to align the plurality of questions with the educational standards related to the topic selected by the user.

19. The system of claim 13 further comprising:
a database for storing the one or more user details, plurality of questions, user response, mastery progress and gamification point.
